(19) United States
(12) Patent Application Publication
(10) Pub. No.: US 2026/0119938 A1
(43) Pub. Date: Apr. 30, 2026

(54) TECHNIQUES FOR RESONANT ENHANCEMENT OF LIGHT IN A QUANTUM INFORMATION PROCESSOR

(71) Applicant: ColdQuanta, Inc., Boulder, CO (US)

(72) Inventor: Mark Saffman, Madison, WI (US)

(73) Assignee: ColdQuanta, Inc., Boulder, CO (US)

(21) Appl. No.: 18/921,683

(22) Filed: Oct. 21, 2024

Related U.S. Application Data
(60) Provisional application No. 63/545,523, filed on Oct. 24, 2023.

(51) Int. Cl. G06N 10/40

(52) U.S. Cl. CPC G06N 10/40

(57) ABSTRACT

Techniques are described for efficiently generating optical traps within a quantum information processor by resonantly enhancing optical trap light using an optical ring resonator. An optical ring resonator may effectively recycle optical trap light in a closed optical path, such that the optical trap light passes through a vacuum chamber many times, reinforcing the intensity of the optical traps. As such, a low power light source may be utilized to generate the optical traps. While such a light source may generate light with a power that is alone insufficient to produce the desired number of optical traps, the optical ring resonator reinforces the intensity of this light through repeated passes through the vacuum chamber, building up light of sufficient intensity to produce the desired number of optical traps in the vacuum chamber.

### CROSS-REFERENCE TO RELATED APPLICATIONS

The present application claims the benefit under 35 U.S.C. § 119 (e) of U.S. Provisional Patent Application No. 63/545,523, filed Oct. 24, 2023, titled “Resonant Enhancement of Light Intensity in a Self-Imaging Resonator for Large Scale Qubit Arrays,” which is hereby incorporated by reference in its entirety.

### BACKGROUND

Quantum computing platforms promise to provide solutions to many computationally intractable problems. In a quantum computing platform, information is stored in quantum bits or “qubits,” and the power of the platform generally increases with the number of qubits that can be independently and simultaneously controlled. In quantum computing platforms comprising qubits such as trapped ions or neutral atoms, directed electromagnetic waves (e.g., microwaves, optical beams) implement independent qubit manipulations, while platforms comprising qubits such as electron dots or superconducting rings use guided RF or microwave beams.

Quantum information processing with neutral atoms offers many exciting opportunities. Neutral atoms can be trapped in flexible geometries and in large numbers using optical trapping techniques. Each individual atom can store a quantum bit of information in stable electronic energy levels, such as two hyperfine ground state energy levels. Such storage has the advantage of long coherence times, enabled by excellent isolation from the environment, near-perfect qubit initialization via optical pumping, individual optical readout of each qubit, and straightforward manipulation of single qubits.

### SUMMARY

According to some aspects, the techniques described herein relate to a quantum information processor, including: a vacuum chamber; at least one light source configured to emit light to produce a plurality of optical traps within the vacuum chamber; and an optical ring resonator including a plurality of optical components configured to produce a closed optical path, the optical ring resonator arranged such that the light emitted by at least one light source is directed into the closed optical path of the optical ring resonator, and wherein at least a portion of the vacuum chamber is arranged within the closed optical path of the optical ring resonator.

According to some aspects, the techniques described herein relate to a method including: generating light configured to produce a plurality of optical traps; directing the light into a closed optical path of an optical ring resonator, the optical ring resonator including a plurality of optical components that produce the closed optical path; and directing the light through a vacuum chamber and around the closed optical path of the optical ring resonator a plurality of times.

The foregoing apparatus and method embodiments may be implemented with any suitable combination of aspects, features, and acts described above or in further detail below. These and other aspects, embodiments, and features of the present teachings can be more fully understood from the following description in conjunction with the accompanying drawings.

### BRIEF DESCRIPTION OF DRAWINGS

Various aspects and embodiments will be described with reference to the following figures. It should be appreciated that the figures are not necessarily drawn to scale. In the drawings, each identical or nearly identical component that is illustrated in various figures is represented by a like numeral. For purposes of clarity, not every component may be labeled in every drawing.

FIG. 1 is a schematic of a neutral atom quantum information processor, according to some embodiments;

FIGS. 2A-2E depict a process of operating the neutral atom quantum information processor of FIG. 1, according to some embodiments;

FIG. 3A depicts energy levels of a neutral atom, according to some embodiments;

FIG. 3B depicts Rabi oscillations of a neutral atom, according to some embodiments;

FIG. 4 is a schematic of an illustrative system for efficiently generating optical traps within a quantum information processor, according to some embodiments;

FIG. 5 is a schematic of a second illustrative system for efficiently generating optical traps within a quantum information processor, according to some embodiments;

FIG. 6 is a schematic of a third illustrative system for efficiently generating optical traps within a quantum information processor, according to some embodiments;

FIG. 7 is a schematic of a fourth illustrative system for efficiently generating optical traps within a quantum information processor, according to some embodiments;

FIG. 8 is a schematic of a fifth illustrative system for efficiently generating optical traps within a quantum information processor, according to some embodiments; and

FIG. 9 illustrates an example of a computing system environment on which aspects of the disclosure may be implemented.

### DETAILED DESCRIPTION

Some quantum information processors utilize different states of optically trapped neutral atoms to store quantum information, and to perform quantum operations on those states. To effectively utilize such a processor for complex quantum applications, such as quantum computing, quantum simulation, quantum sensors, etc., it may be necessary or desirable to optically trap many thousands, or even millions, of neutral atoms. While the power needed to generate an optical trap varies with the type of atom and other factors, typically between 1 mW and 10 mW of power is needed. However, the power needed to generate the optical traps for a collection of neutral atoms generally increases with the number of neutral atoms. As such, while a comparatively low power is needed to produce a single trap, a quantum information processor would require power of somewhere between 1 kW and 10 kW to trap a million neutral atoms. Optical sources at this power are specialized, expensive and put stringent demands on the power handling capabilities of the optical system used to form the traps.

The inventors have recognized and appreciated techniques for efficiently generating optical traps within a quantum information processor by resonantly enhancing optical trap light using an optical ring resonator. In particular, the inventors have recognized and appreciated that very little of the power within optical trap light is lost by creating the optical trap, since the wavelength of an optical trap is generally detuned from an optical transition and scattering rates are very low. For instance, more than 99.99% of the power that is directed into a vacuum chamber to create an optical trap may pass out of the other side of the vacuum chamber.

Techniques described herein use an optical ring resonator to direct the optical trap light around a closed optical path, such that the optical trap light passes through the vacuum chamber many times, reinforcing the intensity of the optical traps. As such, a low power light source may be utilized to generate the optical traps. While such a light source may generate light with a power that is alone insufficient to produce the desired number of optical traps, the optical ring resonator reinforces the intensity of this light through repeated passes through the vacuum chamber, building up light of sufficient intensity to produce the desired number of optical traps.

According to some embodiments, the optical ring resonator may comprise at least one dichroic mirror that is configured to reflect light for generating optical traps (this light is also referred to herein as “trap light”), and to transmit light of other wavelengths used within the quantum information processor. For instance, a quantum information processor often includes multiple light sources configured to produce light at different wavelengths, such as light sources to generate traps, rearrange atoms, perform Rydberg excitations of neutral atoms, apply phase gates, and/or direct a Raman beam onto neutral atoms. While it may be advantageous to circulate light for generating traps in the optical ring resonator, it may be undesirable to circulate other types of light, particularly light that is to be directed into the vacuum cell for a time period that is less than the optical lifetime of the optical ring resonator. A dichroic mirror may be configured to reflect the trap light around the ring of the optical ring resonator while transmitting some types of light from within the ring to outside of the ring, thereby allowing both types of light to be directed into the vacuum chamber while only recirculating the trap light. In some cases, the dichroic mirror may be configured to recirculate multiple types of light, including the trap light, while transmitting other types of light.

According to some embodiments, the optical ring resonator may comprise at least four optical components that are configured to be reflective to the trap light and that direct the trap light in a closed optical path (e.g. a loop). A vacuum chamber comprising neutral atoms may be arranged along the closed optical path so that the trap light passes repeatedly through the same locations in the vacuum chamber as it makes repeated circuits around the closed optical path. In some embodiments, the at least four optical components comprise one or more dichroic mirrors and/or one or more curved mirrors (e.g., spherical mirrors).

According to some embodiments, the optical ring resonator may be configured in a self-imaging configuration or a quasi self-imaging configuration. Trap light generally comprises a pattern of light, such as an array, to trap atoms in discrete locations within a vacuum chamber. It may be desirable that when the trap light makes a single round trip around the closed optical path of the optical ring resonator, an optical pattern in the trap light is imaged onto itself so that the same locations in the vacuum chamber are repeatedly reinforced. In a quasi self-imaging configuration, the optical ring resonator is configured so that a trap light optical pattern is imaged onto itself when the pattern is inversion symmetric, whereas in a self-imaging configuration the optical ring resonator is configured so that a trap light optical pattern is imaged onto itself irrespective of the pattern's symmetry.

According to some embodiments, the optical ring resonator may be configured in a quasi self-imaging configuration by arranging an optical path length of the closed optical path of the resonator L to be L=4f, where f is the focal length of one lens, or of multiple lenses, of the optical ring resonator that are arranged within the closed optical path of the resonator. Alternatively, the optical ring resonator may be configured in a self-imaging configuration by arranging an optical path length of the closed optical path of the resonator L to be L=8f, where f is the focal length of one lens, or of multiple lenses, of the optical ring resonator that are arranged within the closed optical path of the resonator.

Following below are more detailed descriptions of various concepts related to, and embodiments of, techniques for efficiently generating optical traps within a quantum information processor by resonantly enhancing optical trap light using an optical ring resonator. It should be appreciated that various aspects described herein may be implemented in any of numerous ways. Examples of specific implementations are provided herein for illustrative purposes only. In addition, the various aspects described in the embodiments below may be used alone or in any combination, and are not limited to the combinations explicitly described herein.

References herein to “light” or a “light source” will be understood to refer to any source of electromagnetic radiation, including but not limited to coherent sources of electromagnetic radiation, and is not intended to limit the scope of such terms to visible light. For instance, a light source as described herein may be configured to produce a microwave beam. Similarly, references to “optical” elements or an “optical” apparatus is not intended to limit the function of such elements or apparatus to use with only visible light. For example, the various embodiments of an optical ring resonator as described herein may be utilized with one or more light sources that produce non-visible light, whether to circulate said light within the resonator or to pass such light through optical components of the resonator.

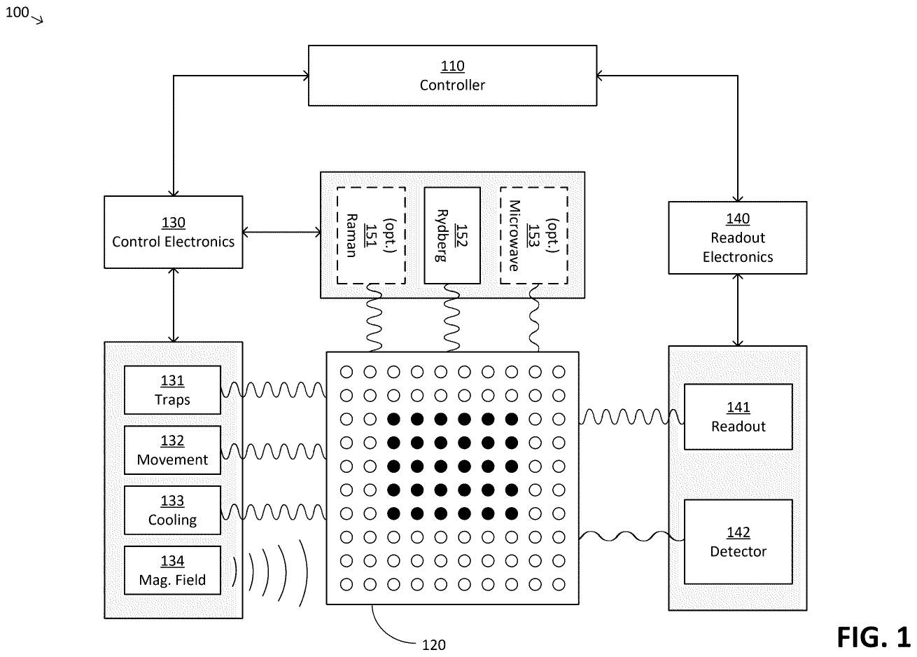

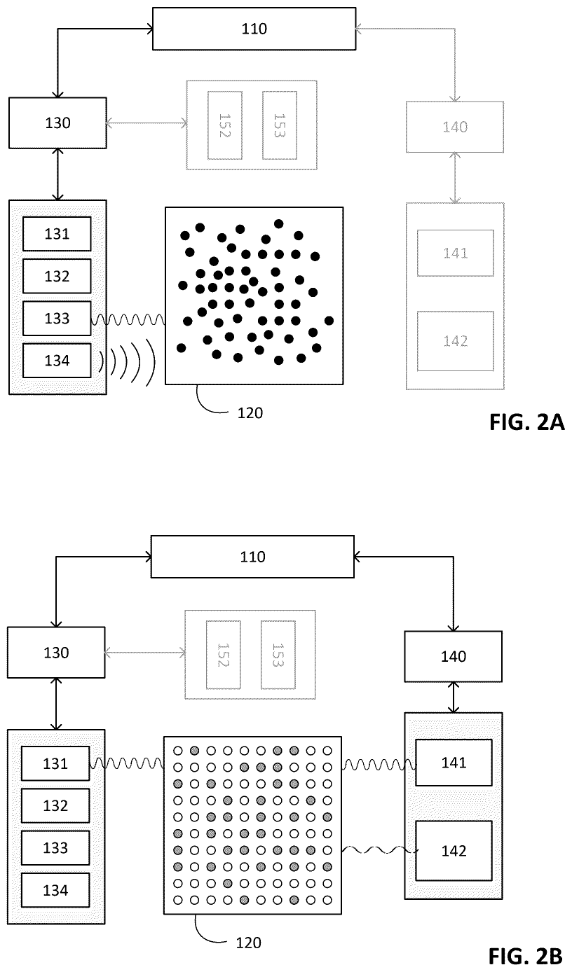

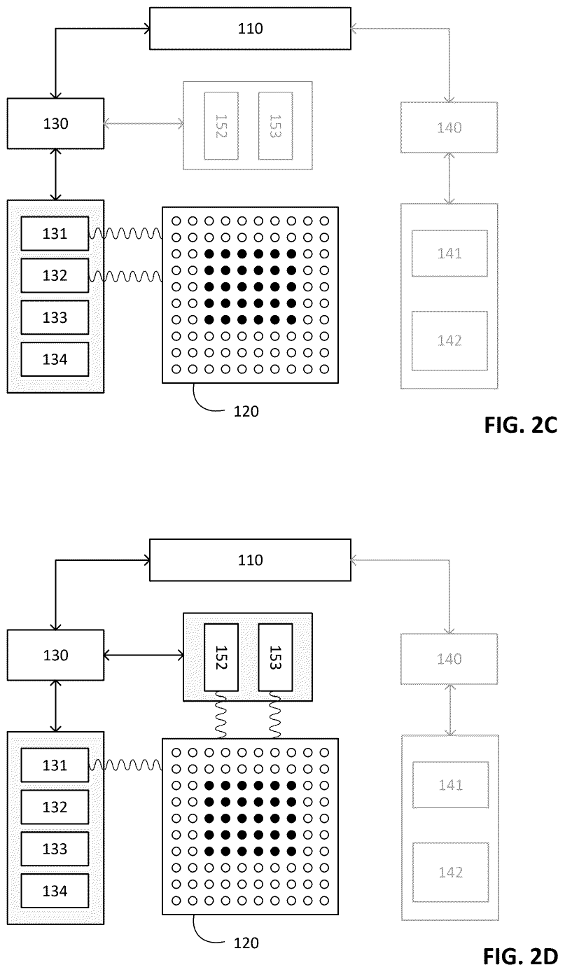

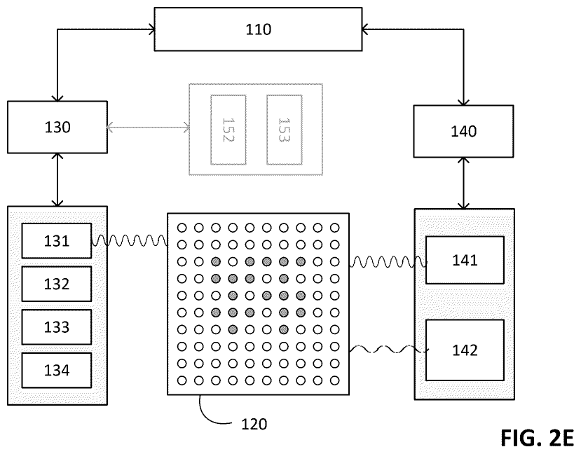

FIG. 1 is a schematic of a neutral atom quantum information processor, according to some embodiments. The illustrative quantum information processor 100 of FIG. 1 is provided as one example system in which the techniques described herein for efficiently generating optical traps within a quantum information processor may be practiced. An example process of operating quantum information processor 100 is depicted in FIGS. 2A-2E, described below.

In the example of FIG. 1, quantum information processor 100 includes an array of neutral atoms 120, which are manipulated, and whose states are measured by, controller 110 via the control electronics 130 and/or readout electronics 140. In a neutral atom quantum information processor such as quantum information processor 100, the neutral atoms may be arranged in an array of traps, with a single atom in each trap. The atomic isotopes are chosen to have a convenient set of electronic quantum states that allow two such states to be used as computational basis states |0 [symbol] and |1 [symbol] , and that also include a Rydberg state |r [symbol] , which is an electronic state with a very high principal quantum number. The states of the atoms may be manipulated by applying electromagnetic pulses (e.g., laser light pulses of selected frequencies) to one or more selected neutral atoms. Logical gates may be performed by manipulating the quantum states of the neutral atoms, such as controlling transitions between the computational basis states |0 [symbol] and |1 [symbol] , allowing for arbitrary single-qubit gates. Entangling gates are performed by coupling one or both of the computational basis states |0 [symbol] and |1 [symbol] to the highly excited Rydberg state |r [symbol] , which produce desirable entangling interactions as a result of the Rydberg blockade effect, which inhibits two nearby atoms from occupying the Rydberg state. The neutral atoms 120 thereby operate as a type of qubit with respect to the computational basis states |0 [symbol] and |1 [symbol] , while also making use of the Rydberg state |r [symbol] . Manipulation of the quantum states of the neutral atoms 120 is described further below.

In the example of FIG. 1, the controller 110 may be configured to generate instructions that, when provided to and executed by, the control electronics 130 and readout electronics 140, perform various operations for control of the neutral atoms 120 as described below. The controller may be configured to generate such instructions using any suitable combination of software and/or hardware. According to some embodiments, controller 110 comprises software executed on a general-purpose processor, an application specific integrated circuit (ASIC), a field-programmable gate array (FPGA), and/or any other suitable controller suitable for controlling the quantum information processor via control electronics 130 and readout electronics 140. In the example of FIG. 1, controller 110 may be configured to receive signals from the control electronics 130 and readout electronics 140 and to generate, based on a received signal, one or more signals to send to either or both of control electronics 130 and readout electronics 140 by executing hardware and/or software logic.

In the example of FIG. 1, the control electronics 130 and readout electronics 140 may each be implemented using any suitable combination of software and/or hardware. In some embodiments, control electronics 130 and/or readout electronics 140 may be, or may comprise, a hardware controller such as an FPGA and/or ASIC.

In the example of FIG. 1, the control electronics 130 may be configured to provide signals to the trap system 131, the movement system 132, the cooling system 133, the magnetic field system 134, the Rydberg system 152, and optionally the Raman system 151 and the microwave system 153 (collectively, the “control systems”) according to instructions and/or other signals received from the controller 110. The control electronics 130 may be configured to receive signals from any one or more of the control systems and to send a signal or signals to any one or more of the control systems and/or to controller 110 in response to a received signal. For instance, the control electronics 130 may be configured to generate, based on a received signal, one or more signals to send to any one or more of the control systems, and/or to controller 110, by executing hardware and/or software logic. For instance, the control electronics 130 may comprise an FPGA programmed to output particular signals that will result in one or more of the control systems performing one or more actions, and may do so in response to one or more signals received from any part of the quantum information processor 100.

According to some embodiments, manipulation of the state of one or more of the neutral atoms 120 may be achieved through various techniques and mechanisms, and the illustrative control systems 151, 152 and 153 are depicted as examples. Some examples of operating these control systems are described below.

In the example of FIG. 1, the readout electronics 140 may be configured to provide signals to the readout system 141 and the detector 142 according to instructions and/or other signals received from the controller 110. The readout electronics 140 may be configured to receive signals from the readout system 141 and the detector 142, and to send a signal or signals to any one or more of the readout system 141, the detector 142, and/or controller 110 in response to a received signal. For instance, the readout electronics 140 may be configured to generate, based on a received signal, one or more signals to send to the readout system 141, the detector 142 and/or to the controller 110 by executing hardware and/or software logic. For instance, the readout electronics 140 may comprise an FPGA programmed to output particular signals that will result in the readout system 141 and/or the detector 142 performing one or more actions, and may do so in response to one or more signals received from any part of the quantum information processor 100.

Descriptions below relating to the quantum information processor 100 operating various elements of the system (e.g., Rydberg system 152) to perform particular operations, will be understood to refer to some combination of the control electronics 130 or readout electronics 140 providing signals to part of the quantum information processor, including but not limited to the above-noted control systems, readout system 141 and/or detector 142, whether in response to instructions and/or other signals received from the controller 110, or otherwise.

According to some embodiments, neutral atoms 120 comprises atoms of a Group I or Group II element, such as rubidium-87, cesium-133, or strontium-87. The neutral atoms may be provided as a low pressure gas (e.g., 10-8 Torr) of such atoms within a vacuum chamber. The neutral atoms 120 may be arranged in any suitable arrangement, including a two-dimensional (2D) or three-dimensional (3D) array, such as a 2D or 3D grid, by operating trap system 131 as described below.

In general, operation of the quantum information processor 100 comprises the following phases. Initially, the neutral atoms 120 are cooled then arranged in an array of traps with a single atom in each trap. This step typically also includes detecting the locations of atoms in the traps, and rearranging some atoms to produce a desired arrangement of atoms, such as the 2D grid array shown in FIG. 1. Subsequently, the quantum states of the atoms may be manipulated (e.g., to perform calculations or to perform calibration processes) through a series of operations that initialize the atoms in one of the two computational basis states |0 [symbol] and |1 [symbol] , or another desired state, and then manipulate the computational basis states |0 [symbol] and |1 [symbol] , the Rydberg state |r [symbol] , and/or any other desired state(s) of the atoms. The states of the atoms may then be measured after the operations to determine whether each atom is in the |0 [symbol] or |1 [symbol] state (although in practice there may be additional states that can, when measured, appear to the readout system as the |0 [symbol] or |1 [symbol] state; the act of measuring the states of the atoms will nonetheless generally be understood to have the goal of measuring the computational basis states).

FIGS. 2A-2E depict this process in more detail, according to some embodiments. In the example of FIGS. 2A-2E, the elements of FIG. 1 that are typically not operational in a given stage are shown greyed out for clarity. FIG. 2A represents an initial stage during which cooling system 133 and magnetic field system 134 are operated to cool and confine the neutral atoms within a desired volume.

According to some embodiments, cooling system 133 comprises one or more lasers configured to cool neutral atoms 120 to a temperature below 1 mK. For instance, cooling system 133 may operate via Doppler cooling in which a laser beam is directed onto an atom, with a frequency slightly below the resonance frequency of a particular electronic transition of the atom. The atoms will repeatedly absorb a photon of the light, losing momentum, and subsequently emit a photon in an arbitrary direction, gaining momentum. On average, because of the frequency detuning from the transition, this leads to a net momentum transfer opposite to the direction of the atom's movement, thereby reducing the speed of the atom. In some embodiments, the cooling system 133 may be configured to produce a plurality of laser beams along multiple different directions and which are configured to direct light onto the neutral atoms at a common frequency. For instance, the cooling system 133 may be configured to produce three pairs of laser beams along the directions of the six semi-axes of a 3D Cartesian coordinate system (e.g., optical molasses). In some embodiments, one or more laser beams produced by the cooling system 133, such as but not limited to the above example of three pairs of laser beams, may be circularly polarized. The cooling system 133 may be configured to produce multiple laser beams by operating multiple lasers and/or by operating suitable optical components to produce multiple laser beams from a single laser.

In some embodiments, the magnetic field system 134 comprises, or may otherwise operate, one or more magnetic field coils to produce a magnetic field within the region of the neutral atoms 120. In the examples of FIG. 1 and FIG. 2A, cooling system 133 is configured to generate a plurality of magneto-optical traps (MOTs) in part by operating the magnetic field system 134. In some embodiments, the magnetic field system 134 comprises two magnetic field coils in an anti-Helmholtz configuration and/or may be configured to produce a quadrupolar, spatially varying magnetic field. During operation, as shown in FIG. 2A, the magnetic field system 134 may be operated concurrently with the cooling system 133, thereby cooling the neutral atoms 120 via Doppler cooling using the cooling system 133, while also confining the atoms to a desired region in space.

Subsequent to or during cooling of the neutral atoms, in the example of FIG. 1 and FIG. 2B, trap system 131 may be operated to produce a plurality of traps within the space in which the neutral atoms are confined by the magnetic field system 134. The traps produced by the trap system 131 may include magnetic and/or optical traps. In some embodiments, the trap system 131 is configured to generate one or more optical tweezers (which may comprise one or more focused laser beams) that can trap one or more individual atoms by attracting an atom to an intensity maximum of light. In some embodiments, the trap system 131 is configured to generate one or more optical bottle beams (which may comprise one or more focused laser beams) that can trap one or more individual atoms by repelling an atom from an intensity maximum of light (so that an atom is trapped in comparatively darker regions between the beams). In some implementations, trap system 131 may be configured to produce both one or more optical tweezers and one or more optical bottle beams. In some embodiments, the trap system 131 is configured to produce a 2D or 3D array (e.g., a 2D or 3D grid) of traps by generating an array of optical tweezers by generating an array of focused laser beams. In some embodiments, the trap system 131 comprises one or more spatial light modulators (SLMs) that may be operated to produce traps in arbitrary positions (e.g., by generating one or more optical tweezers). Typical distances between individual traps may in some embodiments be between 1 μm and 10 μm, such as approximately 2 μm.

In some embodiments, trap system 131 comprises one or more acousto-optic deflectors (AODs) that may be operated to produce one or more traps. AODs deflect an incident laser beam into multiple beams, where the deflection angle of each beam is controlled by the acoustic wave frequencies applied to the deflector. Continuously varying the frequencies changes the deflection angles of the laser beams, reconfiguring the beams in one dimension to form traps with the beams. In some embodiments, the trap system 131 includes one or more AODs in addition to one or more SLMs. In at least some cases, traps produced by AODs may be more easily moved than traps produced by SLMs, though may have constraints on their positioning.

In some embodiments, trap system 131 may be configured to produce an optical lattice. For instance, the trap system 131 may comprise one or more acousto-optic modulators (AOMs), which may be operated to produce a spatially periodic polarization pattern that may be used to trap neutral atoms.

Frequently, not all of the traps produced by the trap system 131 will trap an atom. In some embodiments, the quantum information processor 100 may be configured to detect which of the traps contain an atom, and in response to move atoms that are detected to produce a desired arrangement of the atoms within traps. As shown in the example of FIG. 2B, the readout system 141 and detector 142 may be operated together to detect the positions of atoms within the traps produced by the trap system 131 by operating the readout system to illuminate the neutral atoms (e.g., with visible light), and detecting a result of said illumination with the detector.

In some embodiments, the readout system 141 is configured to illuminate the neutral atoms 120 with an imaging beam, such as a laser-scanning imaging beam. In some embodiments, the readout system 141 is configured to produce light with a wavelength selected to cause fluorescence of the neutral atoms 120 (e.g., a wavelength corresponding to an optical transition). The detector 142 may be configured to detect locations at which fluorescence light was produced, so that, for example, atoms are visible as bright spots, and empty traps are visible as dark spots. In the case of the neutral atoms 120 being rubidium-87 atoms, for example, the imaging beam may include light with a wavelength of 780 nm to cause fluorescence of the rubidium-87 atoms.

In some embodiments, the detector 142 comprises an optical imaging device, such as a charge coupled device (CCD), a complementary metal-oxide semiconductor (CMOS) imaging device, or an electron multiplying CCD (EMCCD) optical camera. In some embodiments, the detector 142 comprises an array of single-pixel photodetectors. In some embodiments, the detector 142 comprises a high numerical aperture (e.g., NA>0.3) lens that focuses light onto an imaging device.

Subsequent to detecting which traps contains atoms as shown in FIG. 2B, the atoms that are present may be rearranged by operating the movement system 132 and the trap system 131, as shown in FIG. 2C. For instance, the controller 110 may provide signals (e.g., data comprising or otherwise indicating executable instructions) to the readout electronics 140 that, when executed by the readout electronics, operate the readout system 141 to illuminate the neutral atoms, and to operate the detector 142 to produce imaging data indicating the positions of atoms present in the traps. The readout electronics 140 may receive the imaging data (or other data indicating the positions of atoms in the traps) and may send one or more signals to the controller 110 indicating the positions of the atoms (e.g., the imaging data or other data indicative of the positions). The controller 110 may be configured to determine a series of operations to be performed by the movement system 132 to rearrange the detected atoms, and may provide signals (e.g., data comprising or otherwise indicating executable instructions) to the control electronics 130 that, when executed by the control electronics, operate the movement system 132 and/or the trap system 131 to move one or more atoms into a new position.

There are various techniques by which atoms can be moved from a trap in one location to a trap in another location. In some embodiments, the movement system 132 is configured to operate one or more SLMs, which are producing the traps, to shift the locations of one or more of the traps, thereby carrying an atom in that trap to a new location. In some embodiments, such translations can be produced by operating the SLM to add defocus to a trap, which will shift the focus and thereby shift the trap. An alternative approach is to operate the SLM or another light source to illuminate an atom with counter-propagating beams of light with the same frequency, so that they form a standing wave. When the frequency of one of the beams is changed, the standing wave moves, carrying the atom along with it. The adjusted beam is returned to its original frequency to halt the atom transportation.

In some embodiments, the quantum information processor 100 includes traps produced by the movement system 132 operating one or more AODs and the AODs may be operated to move atoms between traps. In some embodiments, the quantum information processor 100 includes traps produced by an optical tweezer (e.g., generated by one or more SLMs as described above) and traps produced the movement system 132 operating one or more AODs, and the optical tweezer and AODs may be operated to transfer atoms between the two types of traps, and to shuttle atoms around between the optical tweezer traps by adjusting the AODs to move the trap array. In some embodiments, the quantum information processor 100 may comprise one or more arbitrary waveform generators (AWGs) configured to control one or more AODs to move atoms (irrespective of whether quantum information processor 100 also includes traps produced by an optical tweezer).

Irrespective of how the atoms are rearranged, the result is a register of neutral atoms held in traps in a desired arrangement, such as the 2D array shown in FIG. 2C. Subsequently, quantum operations may be performed on the neutral atom register, including operations for calculation and/or calibration. The operation of the quantum information processor 100 to perform such operations is shown in FIG. 2D, and generally include applying laser and/or microwave pulses to one or more of the atoms to manipulate the quantum state of the one or more atoms.

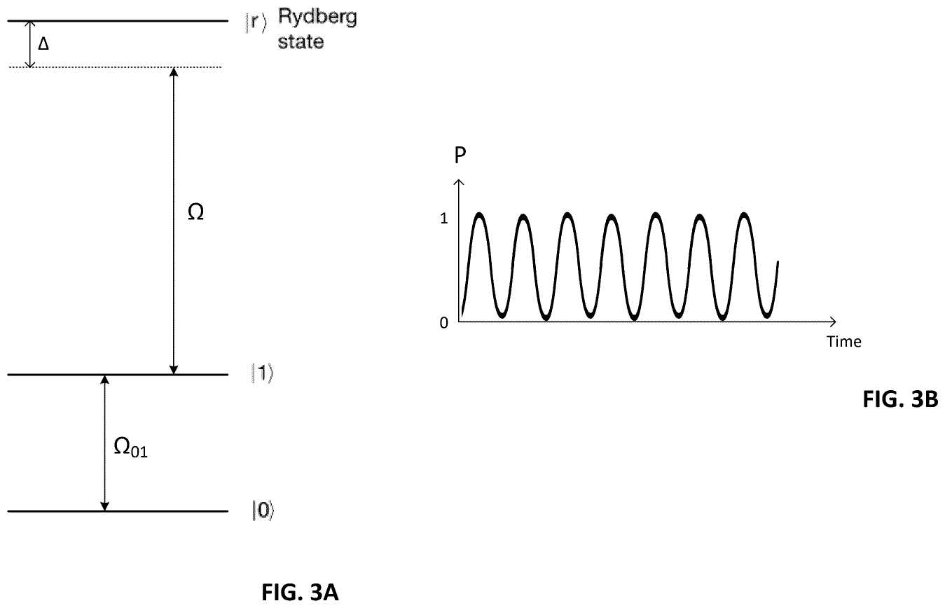

As shown in FIG. 3A, the quantum states of interest for the type of neutral atom in quantum information processor 100 include the energy levels selected to represent the computational basis states |0 [symbol] and |1 [symbol] , and the highly excited Rydberg state |r [symbol] . Driving fields applied to a neutral atom that are at or close to resonance between a pair of these energy levels excite coherent oscillations between those states, also called Rabi oscillations. The Rabi oscillations are oscillations of quantum mechanical amplitudes and expectation values of level populations, rather than discrete processes of absorption and emission of photons. The oscillating amplitudes indicate the probability of finding the atom in a certain state when the state is measured, as shown in FIG. 3B, which depict the oscillating probability of measuring the atom to be in a particular electronic state after a driving field is applied for a given amount of time. The probability shown may for example, be the probability of measuring the atom to be in the state |1 [symbol] , or the probability of measuring the atom to be in the state |r [symbol] . When the driving field is applied for a fraction of a period at the frequency of oscillation (the Rabi frequency), the atom may be placed in a superposition of states, which may be seen in FIG. 3B since the probability lies between 0 and 1 except for whole or half periods of the oscillations. In addition, a level of detuning of a driving field from a transition frequency (e.g., transition frequency Ω₀₁) will alter the Rabi frequency of the oscillations. As such, adjusting the frequency of the driving field will also adjust the quantum operation performed by the driving field. In general, a desired superposition between a pair of states can be produced by selecting the frequency, duration, intensity and/or phase of the driving field appropriately.

Transitions between the |0 [symbol] and |1 [symbol] states can, in some approaches, be driven by microwave pulses. The atoms in optical traps are generally too close together for a microwave pulse to be focused on a single atom, but microwave pulses can drive transitions between the states for a plurality of atoms (which may include all of the neutral atoms 120, or a portion thereof). In other approaches, a transition between the |0 [symbol] and |1 [symbol] states of a single atom (or a plurality of atoms) can be driven optically by driving Raman transitions. In the example of FIG. 1, the optional Raman system 151 is configured to be operated to drive such transitions between the |0 [symbol] and |1 [symbol] states.

According to some embodiments, the optional Raman system 151 is configured to operate two phase-locked lasers with a frequency difference equal to the frequency difference between the |0 [symbol] and |1 [symbol] states, Ω₀₁. In this approach, the computational basis states |0 [symbol] and |1 [symbol] are effectively coupled via excitation to a higher energy state. Such lasers generated by the Raman system 151 may be focused on one or more neutral atoms as desired, for instance by operating one or more AOMs and/or AODs.

In some embodiments, the Raman system 151 is configured to direct a global Raman beam onto all (or at least a plurality of) the neutral atoms 120, and is additionally configured to direct a secondary Raman beam onto one or more neutral atoms as desired, such that the |0 [symbol] and |1 [symbol] states in a given neutral atom are coupled only when both Raman beams are directed onto the atom. By activating and deactivating (or adjusting the direction of) the secondary Raman beam onto a neutral atom, the coupling may be turned on and off. In some cases, both Raman beams may be produced by the same laser, and arranged with suitable optical components to produce the separate beams.

In some embodiments, the optional microwave system 153 is configured to direct a global microwave pulse onto all (or at least a plurality of) the neutral atoms 120, and a source of electromagnetic radiation (e.g., Raman system 151, Rydberg system 152 or otherwise) is configured to direct a beam, such as a Stark shifting beam, onto one or more neutral atoms as desired, such that the |0 [symbol] and |1 [symbol] states are coupled for an atom only when the microwave pulse and the beam are both directed onto the atom.

In some embodiments, the microwave system 153 and the Rydberg system 152 (or a part thereof) may be configured to drive single-qubit operations of the neutral atoms 120. In particular, the microwave system 153 may be operated to perform one type of single-qubit operation on all, or on a large number of the neutral atoms 120, and another source of electromagnetic radiation (e.g., Rydberg system 152 or a part thereof) may, at other times, drive another type of single-qubit operation of individual neutral atoms. For instance, in some embodiments the microwave system 153 is configured to perform global qubit rotations around equatorial axes in the Bloch sphere, and the Rydberg system 152 is configured to direct a beam onto one or more individual qubits to perform rotations around the Z axis in the Bloch sphere. By performing some ordered combination of either or both of these two types of operations, an arbitrary single-qubit gate on any individual neutral atom can be realized. As described below, the Rydberg system 152 may be configured to direct laser light at two different wavelengths onto a neutral atom to drive transitions between the |1 [symbol] and |r [symbol] states. In some cases, the rotations around the Z axis on single qubits may be performed by directing laser light having one of the two different wavelengths onto a neutral atom.

In the illustrative example of FIGS. 2A-2E, the optional Raman system 151 is not included, and single qubit gates are performed using the above-described approach of operating the microwave system 153 to perform one type of single-qubit operation on all, or on a large number of the neutral atoms 120, and operating the Rydberg system 152 or a part thereof to drive another type of single-qubit operation of individual neutral atoms.

In some embodiments, the Raman system 151 is configured to produce a frequency-modulated laser beam that is modulated to produce low-noise sidebands at the frequency difference between the |0 [symbol] and |1 [symbol] states, and subsequently passed through a dispersive element, thereby producing an amplitude-modulated beam that couples the two states.

In some embodiments, the Raman system 151 is configured to produce a global pulse that couples the |0 [symbol] and |1 [symbol] states for the purposes of applying the same operation to all of the neutral atoms. In such configurations, the Raman system 151 may also be configured in any one or more of the above ways to couple the |0 [symbol] and |1 [symbol] states in individual atoms.

According to some embodiments, the Raman system 151 may comprise one or more AWGs configured to be operated in conjunction with a laser source to shape pulses of Raman beams, and/or to configure pulses through in-phase and quadrature (“IQ”) control of the source.

In the example of FIG. 1, transitions between the |1 [symbol] and |r [symbol] states, which are for instance relied upon when performing entangling gates, are controlled by Rydberg system 152. In some embodiments, the Rydberg system 152 is configured to direct laser light at two different wavelengths onto one or more neutral atoms to couple the |1 [symbol] and |r [symbol] states. For example, the Rydberg system 152 may be configured to direct a bichromatic laser beam onto one or more neutral atoms to couple the |1 [symbol] and |r [symbol] states. As one example, for rubidium-87 atoms, the Rydberg system 152 may be configured to direct a bichromatic laser beam comprising 420 nm light and 1013 nm light onto one or more neutral atoms.

In some embodiments, the Rydberg system 152 is configured to direct laser light at one frequency onto all (or at least a plurality of) the neutral atoms 120, and is additionally configured to direct a secondary Rydberg beam onto one or more neutral atoms as desired, wherein activating and deactivating the secondary Rydberg beam turns the coupling between the |1 [symbol] and |r [symbol] states on and off. As one example, for rubidium-87 atoms, the Rydberg system 152 may be configured to direct a 1013 nm laser beam onto all of the neutral atoms, and to selectively direct pulses of a secondary laser beam at 420 nm onto one or more neutral atoms. The laser light directed onto all (or a plurality of) the neutral atoms may also be activated and deactivated over the time period of one or more operations, with the secondary Rydberg beam providing finer timing control over activation and deactivation of the coupling (e.g., the 1013 nm laser beam is directed onto all the neutral atoms for a time period in which one or more Rydberg excitations are performed, and during that period, the secondary Rydberg beam is turned on and off several times).

The Rydberg system 152 may be operated to direct any of the above laser beams onto neutral atoms at least in part by operating one or more AOMs and/or AODs to address individual atoms, pairs of atoms, or other groups of atoms.

According to some embodiments, one or more of the neutral atoms may be moved between traps in between quantum operations to ensure arbitrary connectivity between the neutral atoms. Such movement may be performed by operating the movement system 132 as described above in relation to FIG. 2C.

Subsequent to any number of manipulations of any number of the neutral atoms by the Rydberg system 152 and/or microwave system 153 as shown in FIG. 2D, the quantum information processor 100 may be operated to measure states of the neutral atoms with respect to the computational basis states |0 [symbol] and |1 [symbol] .

In some embodiments, the quantum information processor 100 may be configured to eject neutral atoms from the traps conditionally based on their state, and operate the readout system 141 and detector 142 to detect the remaining neutral atoms, thereby measuring the state of each of the neutral atoms. For instance, the quantum information processor 100 may be configured to eject neutral atoms from the traps when the neutral atoms are in the |1 [symbol] state and to retain the neutral atoms in the traps otherwise, then to detect in which traps neutral atoms remain. The detected remaining atoms after ejection of the other neutral atoms in this example may be determined to have been measured in the |0 [symbol] state. Such a process may also be performed in which neutral atoms are ejected conditionally on being in the |0 [symbol] state, thereby retaining neutral atoms in the |1 [symbol] state. In some embodiments, the trap system 131 may be operated during such a process to adjust the depth of the potential wells of the traps (e.g., to make the traps deeper).

According to some embodiments, the quantum information processor 100 may operate Raman system 151 and/or Rydberg system 152 to direct a resonant laser pulse that “blows away” atoms in either of the states |0 [symbol] or |1 [symbol] . In the example of FIG. 1 and FIG. 2E, the readout system 141 is configured to illuminate the neutral atoms 120 with an imaging beam subsequent to directing a resonant laser pulse to blow away atoms in either of the states |0 [symbol] or |1 [symbol] . The detector 142 may be configured and operated as described above to detect locations at which fluorescence light was produced.

In some embodiments, the quantum information processor 100 may be configured to perform non-destructive readout of the neutral atoms 120 by operating the readout system 141 and detector 142 to measure the state of each of the neutral atoms. In particular, the readout system 141 may be configured to illuminate the neutral atoms 120 with an imaging beam that causes the neutral atoms to fluoresce in different ways depending on their state. For instance, the imaging beam may cause only atoms in one of the states to fluoresce, or may cause atoms in one state to fluoresce in a different way (e.g., at a different intensity or at a different wavelength) from atoms in the other state. The detector 142 may be configured and operated as described above to detect fluorescence produced from the neutral atoms in this manner.

According to some embodiments, the quantum information processor 100 may include a variety of hardware and optical elements for directing, transmitting, modifying, focusing, dividing, modulating, and amplifying generated light fields to various shapes, sizes, profiles, orientations, polarizations, and intensities, as well as any other desirable properties. Some illustrative optical elements such as SLMs, AODs and AOMs have been described above. The quantum information processor 100 may also include other optical elements, such as various beam splitters, beam shapers, shapers, diffractive elements, refractive elements, gratings, mirrors, polarizers, modulators and so forth. While particular examples of operating hardware and optical elements are provided above with respect to particular elements of quantum information processor 100 shown in FIG. 1, it will be appreciated that multiple elements in FIG. 1 may share the same hardware and/or optical elements, and there is no requirement that such hardware and optical elements are separated into distinct units as shown in FIG. 1. For instance, the same SLM or AOD could be operated by multiple ones of the systems shown in FIG. 1 (e.g., the same AOD could be operated by the trap system 131 and by the Raman system 151).

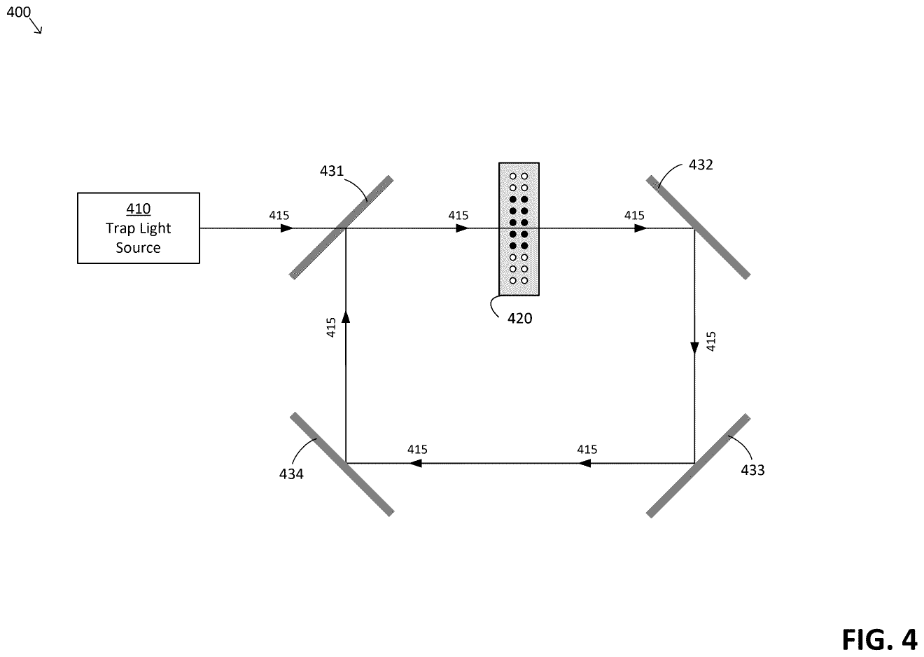

FIG. 4 is a schematic of an illustrative system for efficiently generating optical traps within a quantum information processor, according to some embodiments. In the example of FIG. 4, system 400 includes a trap light source 410, which is a light source configured to emit trap light, and a vacuum chamber 420. System 400 may represent a portion of a quantum information processor, such as quantum information processor 100 shown in FIG. 1, in which case the trap light source 410 is an example of trap system 131, and the vacuum chamber 420 is an example of a vacuum chamber housing neutral atoms 120.

Trap light source 410 may be configured in any manner described above in relation to trap system 131, such as but not limited to: generating one or more optical tweezers that each trap a single atom; operating one or more spatial light modulators (SLMs) to produce traps in arbitrary positions within the vacuum chamber 420; and/or operating one or more acousto-optic deflectors (AODs) to deflect a laser beam into multiple beams that form traps. As such, trap light source 410 may, for instance, comprise one or more SLMs and/or AODs (or otherwise produce light that is incident on one or more SLMs and/or AODs), in addition to any number of light sources that can be arranged to interact with optical components (such as, but not limited to, SLMs and/or AODs) to produce the trap light.

Irrespective of how the trap light source 410 is configured to emit light to produce a plurality of optical traps within vacuum chamber 420, the trap light 415 is directed to initially pass through an optical component, which in the example of FIG. 4 is mirror 431, and to then be incident on the vacuum chamber 420. The light then produces a plurality of optical traps within the vacuum chamber. As noted above, the vast majority of light used to produce an optical trap passes through the vacuum chamber. In the example of FIG. 4, this remaining light is incident on a mirror 432 arranged on the opposing side of the vacuum chamber to mirror 431. Mirror 432 includes a reflective surface that causes the light to be reflected onto mirror 433, which includes a reflective surface that reflects the light onto mirror 434, which includes a reflective surface that reflects the light back onto mirror 431, where it is reflected from a reflective surface of the mirror 431 into the vacuum chamber. In this manner, the trap light 415 is circulated repeatedly around the closed optical path represented in FIG. 4 by the rectangular path from mirror 431, to mirror 432, to mirror 433, and back to mirror 434. In the example of FIG. 4, the combination of mirror 431, mirror 432, mirror 433, and mirror 434 arranged as shown, outside of the vacuum chamber 420 and configured as described below, represents an optical ring resonator.

According to some embodiments, the mirror 431 may include any optical component that can both transmit light of a particular wavelength through the component when the light is incident on one side of the component, and to reflect light of that wavelength when that light is incident on the opposing side of the component. While mirror 431 is shown in FIG. 4 as having a flat surface, it need not be implemented with a flat surface, and may generally have any suitable shape. In some embodiments, mirror 431 is a dichroic mirror configured to transmit the trap light 415 emitted from the trap light source 410 and incident on one side (e.g., face) of the mirror, and to reflect the light directed onto the opposing side (e.g., opposing face) of the mirror. In some embodiments, the dichroic mirror 431 may be arranged to transmit a range of wavelengths that include the wavelength of the trap light 415. The bandwidth of this range of wavelengths may be small, such as less than 1 nm, or less than 0.5 nm. In some embodiments, the dichroic mirror 431 may be configured to transmit light within multiple, non-contiguous wavelength ranges, one of which includes the wavelength of the trap light 415.

In some embodiments, one or more of mirror 432, mirror 433 and mirror 434 includes a curved surface on which light circulating around the optical ring resonator is incident. A curved surface may include a convex curved surface or may include a concave curved surface. For instance, any one or more of these mirrors may be a spherical mirror (whether concave or convex). In some embodiments, mirror 431 and mirror 432 are dichroic mirrors, and mirror 433 and mirror 434 are mirrors with a curved surface (e.g., each is either a concave spherical mirror or a convex spherical mirror).

In some embodiments, one or more of mirror 431, mirror 432, mirror 433 and mirror 434 comprise a dielectric coating to reduce optical losses from reflection.

In some embodiments, the trap light emitted by the trap light source 410 is a pattern of light, or comprises a pattern of light. The pattern of light may comprise multiple separate regions of light separated by regions in which there is no light, such as an array of circular regions of light (e.g., arranged as a 2-dimensional grid). In some embodiments, such a pattern is emitted by one or more SLMs that are part of the trap light source 410.

In some embodiments, the trap light emitted by the trap light source 410 has a wavelength that is greater than or equal to 700 nm, 750 nm, 800 nm, 825 nm, 850 nm, 875 nm, 1000 nm, 1050 nm, or 1075 nm. In some embodiments, the trap light emitted by the trap light source 410 has a wavelength that is less than or equal to 1100 nm, 1075 nm, 1050 nm, 1000 nm, 900 nm, 875 nm, 850 nm, 825 nm, 800 nm, or 750 nm. Any suitable combinations of the above-referenced ranges are also possible (e.g., the trap light emitted by the trap light source 410 has a wavelength that is greater or equal to 875 nm and less than or equal to 850 nm, the trap light emitted by the trap light source 410 has a wavelength that is greater or equal to 1075 nm and less than or equal to 1050 nm, etc.). The wavelength of the trap light may be selected to be blue-shifted or red-shifted relative to a resonance wavelength of the atoms within the vacuum chamber. For instance, optical tweezers may be configured to produce light that is red-shifted relative to a resonance wavelength of the atoms so that atoms are attracted to intensity maxima of the light. Alternatively, optical bottle beams may be configured to produce light that is blue-shifted relative to a resonance wavelength of the atoms so that atoms are repelled from intensity maxima of the light.

According to some embodiments, system 400 comprises one or more piezoelectric controls coupled to any one or more of mirror 431, mirror 432, mirror 433, and mirror 434. Such a piezoelectric controller may be configured to adjust a position of at least part of one or more of these mirrors to provide fine adjustment of the optical path length of the optical ring resonator.

It will be appreciated that, in the example of FIG. 4, the light traversing the paths shown is labeled throughout as trap light 415, though in general there may be variations in one or more properties between the light in one part of the path shown and another part. For instance, there may be minor variations in intensity and/or wavelength of the trap light 415 at one part of the path shown compared with another part. As such, the use of consistent labeling for the trap light 415 is not intended to indicate that the properties of the light are perfectly consistent throughout this path.

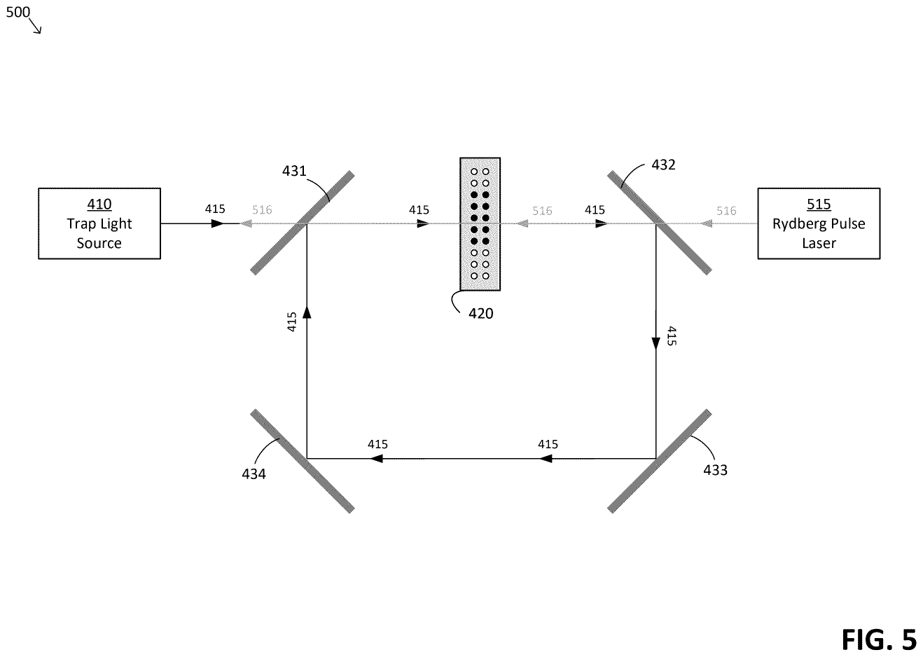

FIG. 5 is a schematic of a second illustrative system for efficiently generating optical traps within a quantum information processor, according to some embodiments. In the example of FIG. 5, quantum information processor 500 includes the trap light source 410, the vacuum chamber 420, mirror 431, mirror 432, mirror 433, and mirror 434 as described above in relation to FIG. 4. In the example of FIG. 5, the combination of mirror 431, mirror 432, mirror 433, and mirror 434 arranged as shown, outside of the vacuum chamber 420 and configured as described below, represents an optical ring resonator.

In the example of FIG. 5, quantum information processor 500 also includes a Rydberg pulse laser 515, which emits Rydberg pulse light 516. Quantum information processor 500 may represent a portion of a quantum information processor, such as quantum information processor 100 shown in FIG. 1, in which case the Rydberg pulse laser 515 is an example of Rydberg system 152.

Rydberg pulse laser 515 may be configured in any manner described above in relation to Rydberg system 152, such as but not limited to: directing laser light at two different wavelengths onto one or more neutral atoms in the vacuum chamber 420 to couple the |1) and |r) states of the atoms; directing a bichromatic laser beam onto one or more neutral atoms in the vacuum chamber 420; and/or operating one or more AOMs and/or AODs to address individual atoms, pairs of atoms, or other groups of atoms in the vacuum chamber 420. As such, Rydberg pulse laser 515 may, for instance, comprise one or more AOMs and/or AODs, in addition to any number of light sources that can be arranged to interact with optical components (such as, but not limited to, AOMs and/or AODs) to emit the Rydberg pulse light 516.

In the example of FIG. 5, the mirror 431 is configured to transmit light having a wavelength of the trap light 415 that is incident on a first side of the mirror, and to reflect light having a wavelength of the trap light 415 that is incident on the second side of the mirror. In addition, the mirror 431 is configured to transmit the light having a wavelength of the Rydberg pulse light 516 emitted from the Rydberg pulse laser 515 when it is incident on the first side of the mirror. For example, the mirror 431 may be configured to reflect 852 nm trap light from that is incident on one face of the mirror (the right side in FIG. 5) and configured to transmit Rydberg pulse light at 420 nm and/or 1013 nm that is incident on that face of the mirror. According to some embodiments, mirror 431 may be a dichroic mirror configured in the above manner.

As shown in FIG. 5, this configuration allows the trap light 415 to circulate around the optical ring resonator represented by the combination of mirror 431, mirror 432, mirror 433, and mirror 434, while also allowing the Rydberg pulse light 516 to pass through the vacuum chamber 420 and through the mirror 431, thereby not being recirculated in the optical ring resonator. As such, the optical traps produced by the trap light in the vacuum chamber 420 may be optically reinforced without also optically reinforcing the Rydberg pulse light. Since the typical duration of a Rydberg pulse may be shorter than the optical lifetime of light in the optical ring resonator, this configuration is thereby beneficial to ensure the lifetime of the Rydberg pulse is not undesirably extended by the optical ring resonator.

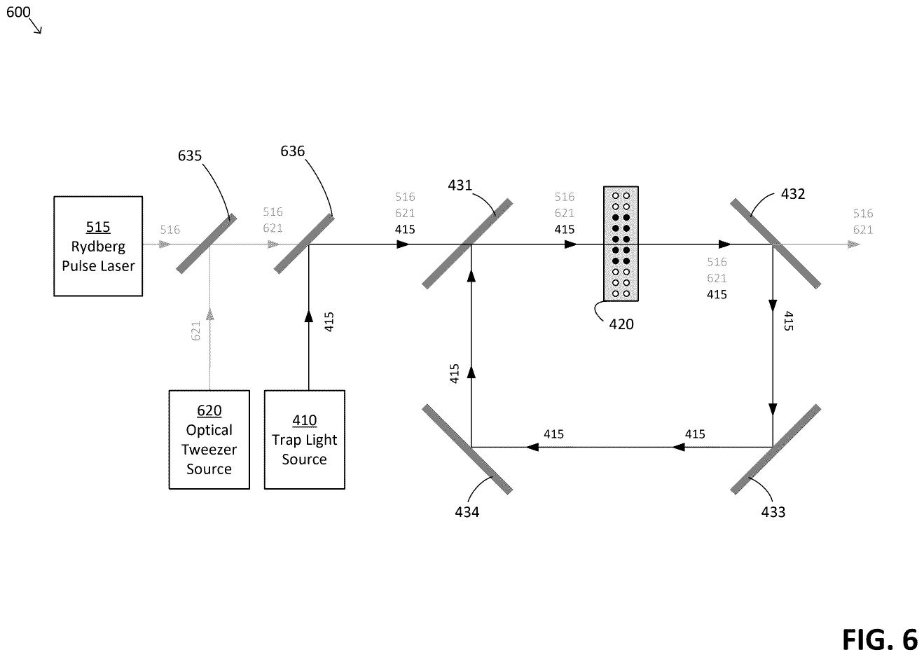

FIG. 6 is a schematic of a third illustrative system for efficiently generating optical traps within a quantum information processor, according to some embodiments. In the example of FIG. 6, quantum information processor 600 includes the trap light source 410, the vacuum chamber 420, mirror 431, mirror 432, mirror 433, and mirror 434 as described above in relation to FIG. 4, and the Rydberg pulse laser 515 as described above in relation to FIG. 5. In the example of FIG. 6, the combination of mirror 431, mirror 432, mirror 433, and mirror 434 arranged as shown, outside of the vacuum chamber 420 and configured as described below, represents an optical ring resonator.

In the example of FIG. 6, quantum information processor 600 also includes an optical tweezer source 620, which emits optical tweezer light 621. Quantum information processor 600 may represent a portion of a quantum information processor, such as quantum information processor 100 shown in FIG. 1, in which case the optical tweezer source 620 may be an example of movement system 132. Quantum information processor 600 also includes mirror 635 and mirror 636, which are each configured to transmit light of a particular wavelengths through the mirror when the light is incident on one side of the mirror, and to reflect light of particular wavelengths when that light is incident on the opposing side of the mirror. In the example of FIG. 6, the mirror 635 is configured to transmit the Rydberg pulse light 516 when it is incident on one side of the mirror, and to reflect the optical tweezer light 621 when it is incident on the other side of the mirror. In addition, the mirror 636 is configured to transmit the Rydberg pulse light 516 and the optical tweezer light 621 when they are incident on one side of the mirror, and to reflect the trap light 415 when it is incident on the other side of the mirror.

Optical tweezer source 620 may be configured in any manner described above in relation to movement system 132, such as but not limited to: illuminating atoms in the vacuum chamber 420 with counter-propagating beams of light with the same frequency, so that they form a standing wave, to shift the positions of optical traps in the vacuum chamber; and/or operating one or more AODs to move atoms between optical traps. As such, optical tweezer source 620 may, for instance, comprise one or more SLMs and/or AODs, in addition to any number of light sources that can be arranged to interact with optical components (such as, but not limited to, AOMs and/or AODs) to emit the optical tweezer light 621.

In the example of FIG. 6, the mirror 635 is configured to transmit light having a wavelength of the Rydberg pulse light 516 that is incident on a first side of the mirror, and to reflect light having a wavelength of the optical tweezer light 621 that is incident on the second side of the mirror. For example, the mirror 635 may be configured to reflect 850 nm optical tweezer light that is incident on one face of the mirror (the right side in FIG. 6) and configured to transmit Rydberg pulse light at 420 nm and/or 1013 nm that is incident on the opposing face of the mirror (the left side in FIG. 6), when the atoms in the vacuum chamber are Rb atoms. Although, the mirror 635 may be configured to transmit other Rydberg pulse light wavelengths, depending on the particular approach used to excite atoms (e.g., 459 nm and/or 1040 nm for Cs atoms, 297 nm for Rb single-wavelength excitation, 318 nm for Cs single-wavelength excitation, etc.). According to some embodiments, mirror 635 may be a dichroic mirror configured in the above manner.

In the example of FIG. 6, the mirror 636 is configured to transmit light having a wavelength of the Rydberg pulse light 516 and to transmit light having a wavelength of the optical tweezer light 621 that is incident on a first side of the mirror, and to reflect light having a wavelength of the trap light 415 that is incident on the second side of the mirror. For example, the mirror 636 may be configured to reflect 852 nm trap light that is incident on one face of the mirror (the right side in FIG. 6) and configured to transmit Rydberg pulse light at 420 nm and/or 1013 nm, as well as 850 nm optical tweezer light that is incident on the opposing face of the mirror (the left side in FIG. 6). According to some embodiments, mirror 636 may be a dichroic mirror configured in the above manner.

In the example of FIG. 6, the mirror 431 is configured to transmit light having a wavelength of the trap light 415, light having a wavelength of the Rydberg pulse light 516 and light having a wavelength of optical tweezer light 621 that is incident on a first side of the mirror, and to reflect light having a wavelength of the trap light 415 that is incident on the second side of the mirror. For example, the mirror 431 may be configured to transmit 852 nm trap light, Rydberg pulse light at 420 nm and/or 1013 nm, and 850 nm optical tweezer light when such light is incident on one face of the mirror (the left side in FIG. 6) and configured to reflect 852 nm trap light when such light is incident on the opposing face of the mirror (the right side in FIG. 6). According to some embodiments, mirror 431 may be a dichroic mirror configured in the above manner.

Also in the example of FIG. 6, the mirror 432 is configured to transmit light having a wavelength of the Rydberg pulse light 516 and light having a wavelength of optical tweezer light 621 that is incident on a first side of the mirror, and to reflect light having a wavelength of the trap light 415 that is incident the first side of the mirror. For example, the mirror 432 may be configured to reflect 852 nm trap light, and to transmit Rydberg pulse light at 420 nm and/or 1013 nm and 850 nm optical tweezer light, when such light is incident on one face of the mirror (the left side in FIG. 6). According to some embodiments, mirror 431 may be a dichroic mirror configured in the above manner.

As shown in FIG. 6, this configuration allows the trap light 415 to circulate around the optical ring resonator represented by the combination of mirror 431, mirror 432, mirror 433, and mirror 434, while also allowing the Rydberg pulse light 516 and the optical tweezer light 621 to pass through the vacuum chamber 420 and through the mirror 431 and mirror 431, thereby not being recirculated in the optical ring resonator. As such, the optical traps emitted by the trap light in the vacuum chamber 420 may be optically reinforced without also optically reinforcing the Rydberg pulse light 516 or the optical tweezer light 621.

The illustrative quantum information processor 600 shown in FIG. 6 may also be implemented such that mirror 432 is configured to reflect light having the wavelength of the optical tweezer light 621 from the face shown on the left in FIG. 6 (i.e., the same face that is configured to reflect light having the wavelength of the trap light 415). In addition, the mirror 431 may be configured to reflect light having the wavelength of the optical tweezer light 621 from the face shown on the right in FIG. 6 (i.e., the same face that is configured to reflect light having the wavelength of the trap light 415). In this configuration, the optical ring resonator represented by the combination of mirror 431, mirror 432, mirror 433, and mirror 434 circulates the optical tweezer light 621 in addition to the trap light 415, without also optically reinforcing the Rydberg pulse light 516.

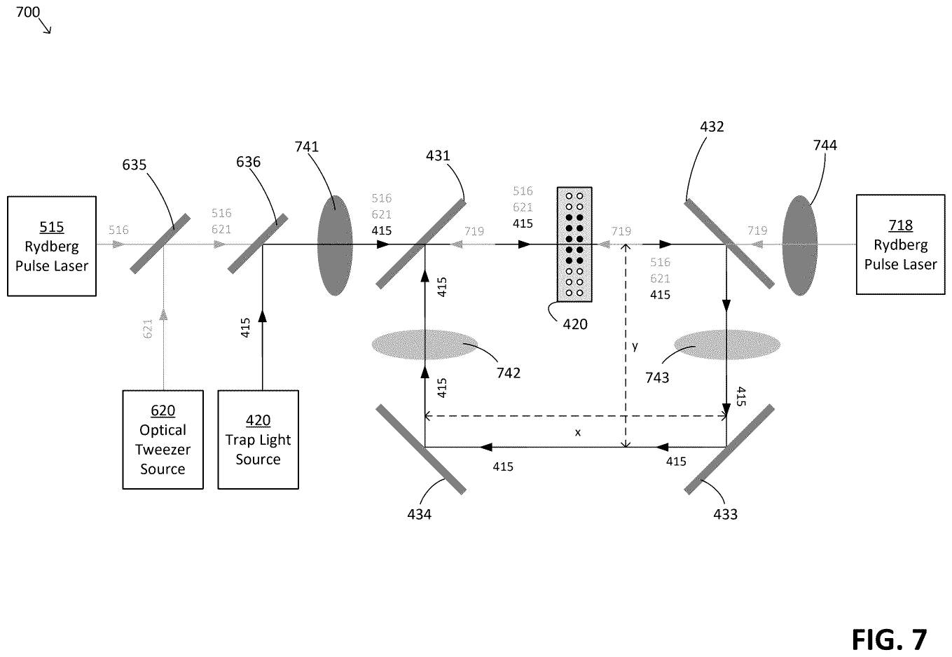

FIG. 7 is a schematic of a fourth illustrative system for efficiently generating optical traps within a quantum information processor, according to some embodiments. In the example of FIG. 7, quantum information processor 700 includes the trap light source 410, the vacuum chamber 420, mirror 431, mirror 432, mirror 433, and mirror 434 as described above in relation to FIG. 4, the Rydberg pulse laser 515 as described above in relation to FIG. 5, and the optical tweezer source 620 as described above in relation to FIG. 6. In the example of FIG. 7, the combination of mirror 431, mirror 432, mirror 433, and mirror 434 arranged as shown, outside of the vacuum chamber 420 and configured as described below, represents an optical ring resonator.

In the example of FIG. 7, quantum information processor 700 also includes a second Rydberg pulse laser 718, which emits Rydberg pulse light 719. Quantum information processor 700 may represent a portion of a quantum information processor, such as quantum information processor 100 shown in FIG. 1, in which case in which case the Rydberg pulse laser 718 is an example of Rydberg system 152. Alternatively, the Rydberg pulse laser 515 and Rydberg pulse laser 718 may together represent an example of Rydberg system 152, and Rydberg pulse laser 718 may be configured in any manner described above in relation to Rydberg system 152. In some embodiments, the Rydberg pulse laser 515 is configured to emit light at one wavelength and the Rydberg pulse laser 718 is configured to emit light at a different wavelength so that the |1 [symbol] and |r [symbol] states of one or more neutral atoms in the vacuum chamber 420 are coupled when the Rydberg pulse light 516 and Rydberg pulse light 719 are both directed onto the one or more neutral atoms. For instance, Rydberg pulse laser 515 may be configured to emit Rydberg pulse light 516 at 1013 nm, whereas Rydberg pulse laser 718 may be configured to emit Rydberg pulse light 719 at 420 nm.

Quantum information processor 700 also includes lens 741, lens 742, lens 743, and lens 744, each of which may be a high performance, high numerical aperture lens (e.g., with a numerical aperture greater than 0.3, or greater than 0.5, or between 0.5 and 0.7). The lens 741 is configured to focus the trap light 415, Rydberg pulse light 516, and optical tweezer light 621 onto neutral atoms in the vacuum chamber 420, and may have any suitable focal length based on the relative arrangement of the lens and the vacuum chamber. Similarly, the lens 741 is configured to focus the Rydberg pulse light 719 onto neutral atoms in the vacuum chamber 420, and may have any suitable focal length based on the relative arrangement of the lens and the vacuum chamber.

According to some embodiments, lens 742 and lens 743 have the same focal length (or substantially the same focal length). In some embodiments, lens 742 and lens 743 each has a focal length f, and the optical path length of the resonator L is a multiple of 4f. For instance, the optical path length of the resonator L may be equal to (or substantially equal to) 4f, 8f, 12f, etc. The optical path length L is represented in FIG. 7 by the distances x and y along the depicted rectangular path (so that in this example L=2x+2y). However, it will be appreciated that, even with an ostensibly rectangular optical path in an optical ring resonator, determining the optical path length may not be so straightforward given more complex geometries used in practical situations. Nonetheless, arranging the optical path length of the optical ring resonator to have such a relationship with the focal length of lens 742 and lens 743 may, as described above, have an advantage of imaging an optical pattern in the trap light onto itself so that the same locations in the vacuum chamber are repeatedly reinforced.

In the example of FIG. 7, mirror 635, mirror 636, mirror 434 and mirror 433 are configured as in the example of FIG. 6 described above. Mirror 431 is also configured as described above in the example of FIG. 6, but is further configured to transmit light having a wavelength of the Rydberg pulse light 719 when it is incident on one side of the mirror, being the same side of the mirror that is configured to reflect light having a wavelength of the trap light 415 that is incident on the second side of the mirror. In the example of FIG. 7, mirror 432 is also configured as described above in the example of FIG. 6, but is further configured to transmit light having a wavelength of the Rydberg pulse light 719 when it is incident on one side of the mirror, being the opposing side of the mirror from the side configured to transmit light having a wavelength of the Rydberg pulse light 516, transmit light having a wavelength of optical tweezer light 621, and reflect light having a wavelength of the trap light 415.

According to some embodiments, an optical ring resonator as shown in any of the examples of FIGS. 4, 5, 6 and 7 may have a build-up factor of greater than or equal to 50, 60, 70, 80 or 90. According to some embodiments, an optical ring resonator as shown in any of the examples of FIGS. 4, 5, 6 and 7 may have a build-up factor of less than or equal to 100, 90, 80, 70 or 60. Any suitable combinations of the above-referenced ranges are also possible (e.g., an optical ring resonator has a build-up factor of greater or equal to 80 and less than or equal to 100, etc.). The power needs of a light source that is resonantly enhanced by the optical ring resonator may be reduced by a factor equal to the build-up factor, in at least some cases.

For instance, in the example of FIG. 7, if the internal surfaces of the optical components have a low loss from reflections (e.g., a loss per surface of less than 0.01), the build-up factor of the optical ring resonator may be suitably high, such as around 90. In this case, returning to the above example of needing 1 kW of power to trap a million neutral atoms, only around 11 W of power would be needed instead, dramatically reducing the power needed to generate optical traps for a large collection of neutral atoms.

While FIGS. 4-7 described above are presented with a particular arrangement of four mirrors all arranged at an angle of 45° to one another to produce an optical ring resonator with a rectangular shape, it will be appreciated that other shapes and arrangements of optical components can also be envisioned that would produce resonant enhancement of trap light while also passing the trap light through the vacuum chamber. For example, square, circular, or other shapes of optical paths may be envisioned, depending on the number and type of optical components used to produce the optical ring resonator, their position, their orientation, etc.

In addition, any of the optical components depicted in FIGS. 4-7, including mirror 431, mirror 432, mirror 433, and mirror 434, may be implemented using any suitable component or components such that the behavior described above is produced. As described above, one way to implement mirror 431 and mirror 432 is with dichroic mirrors that are arranged to transmit or reflect particular wavelengths that are incident on a particular side or sides of the mirror. However, other ways to select optical components that produce the same behavior may also be envisioned and are intended to be part of the present disclosure. For example, prisms and/or diffraction gratings may additionally or alternatively be employed as such an optical component and configured to transmit or reflect particular wavelengths.

Alternatives to the examples of FIGS. 4-7 may further be envisioned, including embodiments in which any one or more of the optical components depicted in FIGS. 4-7, including mirror 431, mirror 432, mirror 433, and mirror 434, may be arranged within the vacuum chamber 420. In such an approach, a greater amount of the closed optical path of the optical ring resonator than shown in any of FIGS. 4-7 may be arranged within the vacuum chamber, and in some cases the entire closed optical path may be arranged within the vacuum chamber.

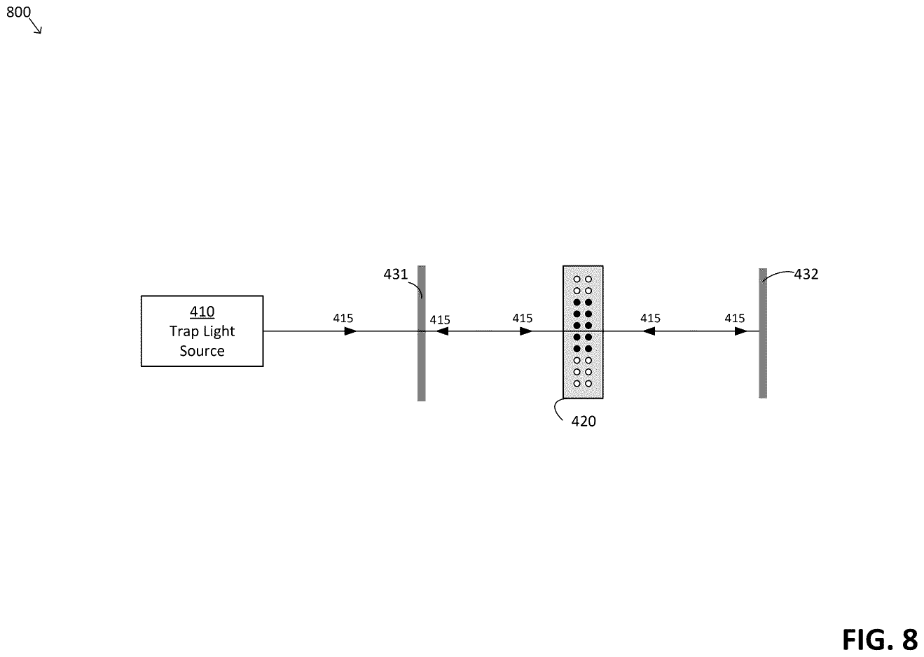

Another alternative implementation to the approach of FIGS. 4-7 is to implement an optical linear resonator instead of an optical ring resonator. FIG. 8 is a schematic of a fifth illustrative system for efficiently generating optical traps within a quantum information processor, according to some embodiments. In the example of FIG. 8, quantum information processor 800 includes the trap light source 410, the vacuum chamber 420, and mirrors 431 and mirror 432 as described above in relation to FIG. 4. In the example of FIG. 8, the combination of mirror 431 and mirror 432 arranged as shown, outside of the vacuum chamber 420 and configured as described below, represents an optical linear resonator.

Unlike the example of FIGS. 4-7, in which the optical path of the resonator is a loop, the optical linear resonator of FIG. 8 is formed with an optical path that passes back and forth through the vacuum chamber 420. In some embodiments, mirror 431 and mirror 432 are configured as mirrors with dichroic coatings in quantum information processor 800 to allow the trap light 415 to be reflected from the mirrors while transmitting light of other wavelengths. In some embodiments, a self-imaging or quasi self-imaging configuration may be produced in quantum information processor 800 through additional optical elements not shown in FIG. 8 and/or by arranging either or both of mirror 431 and mirror 432 with a suitable curvature.

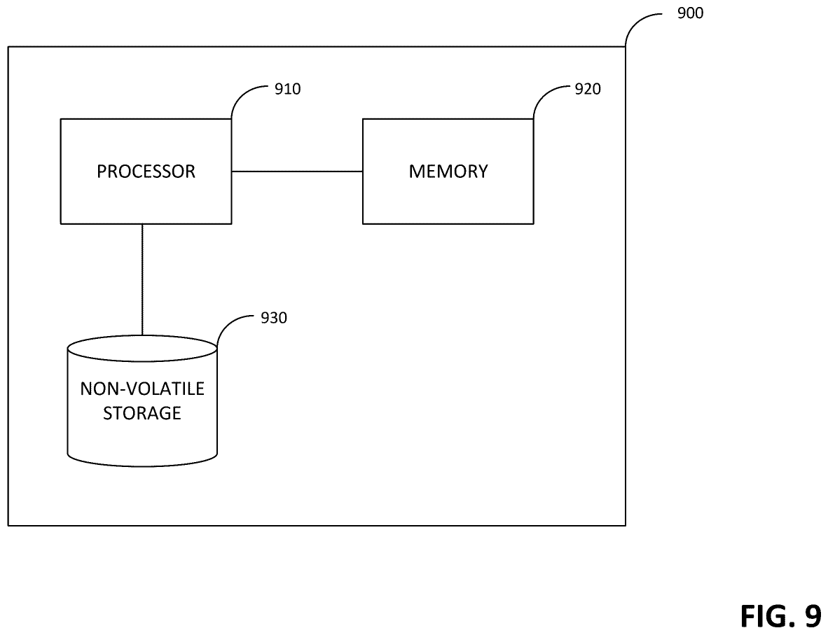

An illustrative implementation of a computer system 900 that may be used to control one or more light sources to direct light through an optical ring resonator as described above is shown in FIG. 9. The computer system 900 may include one or more processors 910 and one or more non-transitory computer-readable storage media (e.g., memory 920 and one or more non-volatile storage media 930). The one or more processors 910 may control writing data to and reading data from the memory 920 and the one or more non-volatile storage media 930 in any suitable manner, as the aspects of the disclosure described herein are not limited in this respect. To perform functionality and/or techniques described herein, the one or more processors 910 may execute one or more instructions stored in one or more computer-readable storage media (e.g., the memory 920, storage media, etc.), which may serve as non-transitory computer-readable storage media storing instructions for execution by the one or more processors 910.

In connection with techniques described herein, code used to, for example, generate a pattern of trap light, operate one or more SLMs, AOMs and/or AODs, etc. may be stored on one or more computer-readable storage media of computer system 900. The one or more processors 910 may execute any such code to perform any of the above-described techniques as described herein. Any other software, programs or instructions described herein may also be stored and executed by computer system 900. It will be appreciated that computer code may be applied to any aspects of methods and techniques described herein.

The various methods or processes outlined herein may be coded as software that is executable on one or more processors that employ any one of a variety of operating systems or platforms. Additionally, such software may be written using any of numerous suitable programming languages and/or programming or scripting tools, and also may be compiled as executable machine language code or intermediate code that is executed on a virtual machine or a suitable framework.

In this respect, various inventive concepts may be embodied as at least one non-transitory computer readable storage medium (e.g., a computer memory, one or more floppy discs, compact discs, optical discs, magnetic tapes, flash memories, circuit configurations in Field Programmable Gate Arrays or other semiconductor devices, etc.) encoded with one or more programs that, when executed on one or more computers or other processors, implement the various embodiments of the present disclosure. The non-transitory computer-readable medium or media may be transportable, such that the program or programs stored thereon may be loaded onto any computer resource to implement various aspects of the present disclosure as described above.

The terms “program,” “software,” and/or “application” are used herein in a generic sense to refer to any type of computer code or set of computer-executable instructions that can be employed to program a computer or other processor to implement various aspects of embodiments as described above. Additionally, it should be appreciated that according to one aspect, one or more computer programs that when executed perform methods of the present disclosure need not reside on a single computer or processor, but may be distributed in a modular fashion among different computers or processors to implement various aspects of the present disclosure.

Computer-executable instructions may be in many forms, such as program modules, executed by one or more computers or other devices. Generally, program modules include routines, programs, objects, components, data structures, etc. that perform particular tasks or implement particular abstract data types. Typically, the functionality of the program modules may be combined or distributed as desired in various embodiments.

Also, data structures may be stored in non-transitory computer-readable storage media in any suitable form. Data structures may have fields that are related through location in the data structure. Such relationships may likewise be achieved by assigning storage for the fields with locations in a non-transitory computer-readable medium that convey relationship between the fields. However, any suitable mechanism may be used to establish relationships among information in fields of a data structure, including through the use of pointers, tags or other mechanisms that establish relationships among data elements.

Having thus described several aspects of at least one embodiment of this disclosure, it is to be appreciated that various alterations, modifications, and improvements will readily occur to those skilled in the art. For instance, aspects of the techniques described herein may be combined in any of the following ways:

Aspect 1. A quantum information processor, comprising: a vacuum chamber; at least one light source configured to emit light to produce a plurality of optical traps within the vacuum chamber; and an optical ring resonator comprising a plurality of optical components configured to produce a closed optical path, the optical ring resonator arranged such that the light emitted by at least one light source is directed into the closed optical path of the optical ring resonator, and wherein at least a portion of the vacuum chamber is arranged within the closed optical path of the optical ring resonator.

Aspect 2. The quantum information processor of aspect 1, wherein the plurality of optical components of the optical ring resonator are arranged outside of the vacuum chamber.

Aspect 3. The quantum information processor of aspect 1, wherein the plurality of optical components includes at least one dichroic mirror.

Aspect 4. The quantum information processor of aspect 3, further comprising a piezoelectric control coupled to the at least one dichroic mirror and configured to adjust a position of at least part of the at least one dichroic mirror to adjust a length of the closed optical path.

Aspect 5. The quantum information processor of aspect 1, further comprising a Rydberg excitation system configured to emit one or more Rydberg excitation beams into the vacuum chamber.

Aspect 6. The quantum information processor of aspect 5, wherein the plurality of optical components includes at least a first dichroic mirror arranged such that the one or more Rydberg excitation beams and the light from the at least one light source are both directed onto the first dichroic mirror.

Aspect 7. The quantum information processor of aspect 6, wherein the first dichroic mirror is configured to reflect the light from the at least one light source and to transmit the one or more Rydberg excitation beams.

Aspect 8. The quantum information processor of aspect 1, wherein the plurality of optical components includes at least one spherical mirror.

Aspect 9. The quantum information processor of aspect 1, wherein the at least one light source comprises at least one spatial light modulator, and wherein the light emitted by the at least one light source includes a pattern of optical trap light produced by the at least one spatial light modulator.

Aspect 10. The quantum information processor of aspect 1, wherein the plurality of optical components includes one or more lenses.

Aspect 11. The quantum information processor of aspect 10, wherein the plurality of optical components includes at least one lens having a focal length f, and wherein the closed optical path has a length of 4f or 8f.

Aspect 12. The quantum information processor of aspect 1, further comprising a lens arranged to focus the light from the at least one light source within the vacuum chamber.

Aspect 13. A method comprising: generating light configured to produce a plurality of optical traps; directing the light into a closed optical path of an optical ring resonator, the optical ring resonator comprising a plurality of optical components that produce the closed optical path; and directing the light through a vacuum chamber and around the closed optical path of the optical ring resonator a plurality of times.

Aspect 14. The method of aspect 13, further comprising optically trapping a plurality of neutral atoms with the light in the vacuum chamber.

Aspect 15. The method of aspect 13, comprising passing the light configured to produce the plurality of optical traps through optical components of the plurality of optical components that include at least one dichroic mirror and at least one lens.

Aspect 16. The method of aspect 13, comprising generating the light configured to produce the plurality of optical traps, which includes a pattern of optical trap light, using at least one spatial light modulator.

Aspect 17. The method of aspect 13, wherein the plurality of optical components includes at least one lens having a focal length f, and wherein the closed optical path has a length of 4f or 8f.

Aspect 18. The method of aspect 13, further comprising directing one or more Rydberg excitation beams into the vacuum chamber.

Aspect 19. The method of aspect 18, wherein the plurality of optical components include a first dichroic mirror, and wherein the method further comprises directing the one or more Rydberg excitation beams through the first dichroic mirror, and further comprising reflecting the light configured to produce the plurality of optical traps from the first dichroic mirror.

Aspect 20. The method of aspect 13, further comprising focusing the light configured to produce the plurality of optical traps onto the vacuum chamber using at least one lens.

Aspect 21. A quantum information processor, comprising: a vacuum chamber; at least one light source configured to emit light to produce a plurality of optical traps within the vacuum chamber; and an optical linear resonator comprising a plurality of optical components configured to produce a closed optical path, the optical linear resonator arranged such that the light emitted by at least one light source is directed into the closed optical path of the optical linear resonator, and wherein at least a portion of the vacuum chamber is arranged within the closed optical path of the optical ring resonator.

Such alterations, modifications, and improvements are intended to be part of this disclosure and are intended to be within the spirit and scope of the disclosure. Further, though advantages of the present disclosure are indicated, it should be appreciated that not every embodiment of the technology described herein will include every described advantage. Some embodiments may not implement any features described as advantageous herein and in some instances one or more of the described features may be implemented to achieve further embodiments. Accordingly, the foregoing description and drawings are by way of example only.

Aspects of the above-described embodiments of the technology described herein can be implemented in any of numerous ways. For example, aspects of the embodiments may be implemented using hardware, software, or a combination thereof. When implemented in software, the software code can be executed on any suitable processor or collection of processors, whether provided in a single computer or distributed among multiple computers. Such processors may be implemented as integrated circuits, with one or more processors in an integrated circuit component, including commercially available integrated circuit components known in the art by names such as CPU chips, GPU chips, microprocessor, microcontroller, or co-processor. Alternatively, a processor may be implemented in custom circuitry, such as an ASIC, or semi-custom circuitry resulting from configuring a programmable logic device. As yet a further alternative, a processor may be a portion of a larger circuit or semiconductor device, whether commercially available, semi-custom or custom. As a specific example, some commercially available microprocessors have multiple cores such that one or a subset of those cores may constitute a processor. Though, a processor may be implemented using circuitry in any suitable format.

Various aspects of the present disclosure may be used alone, in combination, or in a variety of arrangements not specifically described in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Also, aspects of the disclosure may be embodied as a method, of which examples have been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

The terms “approximately” and “about” may be used to mean within ±20% of a target value in some embodiments, within ±10% of a target value in some embodiments, within ±5% of a target value in some embodiments, and yet within ±2% of a target value in some embodiments. The terms “approximately” and “about” may include the target value. The term “substantially equal” may be used to refer to values that are within ±20% of one another in some embodiments, within ±10% of one another in some embodiments, within ±5% of one another in some embodiments, and yet within ±2% of one another in some embodiments.

The term “substantially” may be used to refer to values that are within ±20% of a comparative measure in some embodiments, within ±10% in some embodiments, within ±5% in some embodiments, and yet within ±2% in some embodiments. For example, a first direction that is “substantially” perpendicular to a second direction may refer to a first direction that is within ±20% of making a 90° angle with the second direction in some embodiments, within ±10% of making a 90° angle with the second direction in some embodiments, within ±5% of making a 90° angle with the second direction in some embodiments, and yet within ±2% of making a 90° angle with the second direction in some embodiments.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

What is claimed is:

1. A quantum information processor, comprising:
a vacuum chamber;
at least one light source configured to emit light to produce a plurality of optical traps within the vacuum chamber; and
an optical ring resonator comprising a plurality of optical components configured to produce a closed optical path, the optical ring resonator arranged such that the light emitted by at least one light source is directed into the closed optical path of the optical ring resonator, and wherein at least a portion of the vacuum chamber is arranged within the closed optical path of the optical ring resonator.

2. The quantum information processor of claim 1, wherein the plurality of optical components of the optical ring resonator are arranged outside of the vacuum chamber.

3. The quantum information processor of claim 1, wherein the plurality of optical components includes at least one dichroic mirror.

4. The quantum information processor of claim 3, further comprising a piezoelectric control coupled to the at least one dichroic mirror and configured to adjust a position of at least part of the at least one dichroic mirror to adjust a length of the closed optical path.

5. The quantum information processor of claim 1, further comprising a Rydberg excitation system configured to emit one or more Rydberg excitation beams into the vacuum chamber.

6. The quantum information processor of claim 5, wherein the plurality of optical components includes at least a first dichroic mirror arranged such that the one or more Rydberg excitation beams and the light from the at least one light source are both directed onto the first dichroic mirror.

7. The quantum information processor of claim 6, wherein the first dichroic mirror is configured to reflect the light from the at least one light source and to transmit the one or more Rydberg excitation beams.

8. The quantum information processor of claim 1, wherein the plurality of optical components includes at least one spherical mirror.

9. The quantum information processor of claim 1, wherein the at least one light source comprises at least one spatial light modulator, and wherein the light emitted by the at least one light source includes a pattern of optical trap light produced by the at least one spatial light modulator.

10. The quantum information processor of claim 1, wherein the plurality of optical components includes one or more lenses.

11. The quantum information processor of claim 10, wherein the plurality of optical components includes at least one lens having a focal length f, and wherein the closed optical path has a length of 4f or 8f.

12. The quantum information processor of claim 1, further comprising a lens arranged to focus the light from the at least one light source within the vacuum chamber.

13. A method comprising:
generating light configured to produce a plurality of optical traps;
directing the light into a closed optical path of an optical ring resonator, the optical ring resonator comprising a plurality of optical components that produce the closed optical path; and
directing the light through a vacuum chamber and around the closed optical path of the optical ring resonator a plurality of times.

14. The method of claim 13, further comprising optically trapping a plurality of neutral atoms with the light in the vacuum chamber.

15. The method of claim 13, comprising passing the light configured to produce the plurality of optical traps through optical components of the plurality of optical components that include at least one dichroic mirror and at least one lens.

16. The method of claim 13, comprising generating the light configured to produce the plurality of optical traps, which includes a pattern of optical trap light, using at least one spatial light modulator.

17. The method of claim 13, wherein the plurality of optical components includes at least one lens having a focal length f, and wherein the closed optical path has a length of 4f or 8f.

18. The method of claim 13, further comprising directing one or more Rydberg excitation beams into the vacuum chamber.

19. The method of claim 18, wherein the plurality of optical components include a first dichroic mirror, and wherein the method further comprises directing the one or more Rydberg excitation beams through the first dichroic mirror, and further comprising reflecting the light configured to produce the plurality of optical traps from the first dichroic mirror.

20. The method of claim 13, further comprising focusing the light configured to produce the plurality of optical traps onto the vacuum chamber using at least one lens.
